(19) United States
(12) Patent Application Publication
(10) Pub. No.: US 2012/0032385 A1
(43) Pub. Date: Feb. 9, 2012

(54) CLAMPING MECHANISM

(75) Inventors: SHEN-CHUN LI, Tu-Cheng (TW); HSIEN-CHUAN LIANG, Tu-Cheng (TW); WEN-LAING TSENG, Tu-Cheng (TW); YUNG-CHIEH CHEN, Tu-Cheng (TW); YU-CHANG PAI, Tu-Cheng (TW); SHOU-KUO HSU, Tu-Cheng (TW)

(73) Assignee: HON HAI PRECISION INDUSTRY CO., LTD., Tu-Cheng (TW)

(21) Appl. No.: 12/981,544

(22) Filed: Dec. 30, 2010

(30) Foreign Application Priority Data
Aug. 6, 2010 (TW) 99126395

(51) Int. Cl. B25B 5/06

(52) U.S. Cl. 269/153

(57) ABSTRACT

A clamping mechanism for holding a workpiece includes an end executor, a driving member, and a contact member detachably mounted on the end executor. The end executor includes a plurality of claws arranged in matrix. The contact member includes a mounting board and a plurality of contact sleeves corresponding to the claws. The driving member is capable of driving the mounting board, moving the contact sleeves to extend the claws, and hold the workpiece.

### BACKGROUND

1. Technical Field

The present disclosure relates generally to robotics, and especially to a clamping mechanism used on a robot.

2. Description of Related Art

A commonly used clamping mechanism includes a plurality of claws for holding a workpiece. The claws are generally standardized, and substantially the same, such that the claws can hold a regular shaped workpiece securely. However, if the workpiece is irregularly shaped, such secure retention may be difficult.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is an isometric view of an embodiment of a clamping mechanism including a plurality of claws and a contact member.

FIG. 2 is an exploded, isometric view of the clamping mechanism of FIG. 1.

FIG. 3 is similar to FIG. 2, but shown in another aspect.

FIG. 4 is an exploded, isometric view of a claw shown in FIG. 1.

FIG. 5 is an exploded, isometric view of the contact member shown in FIG. 1.

### DETAILED DESCRIPTION

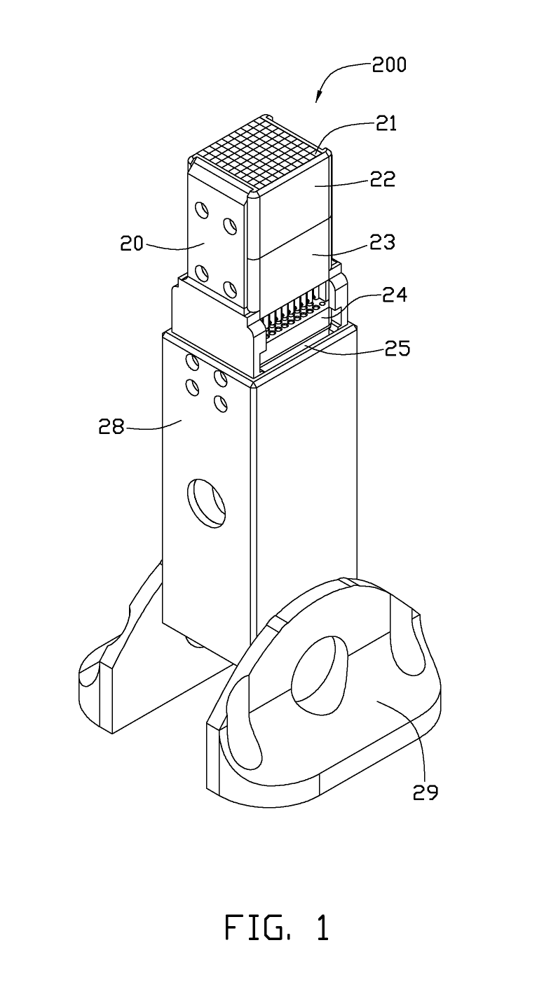

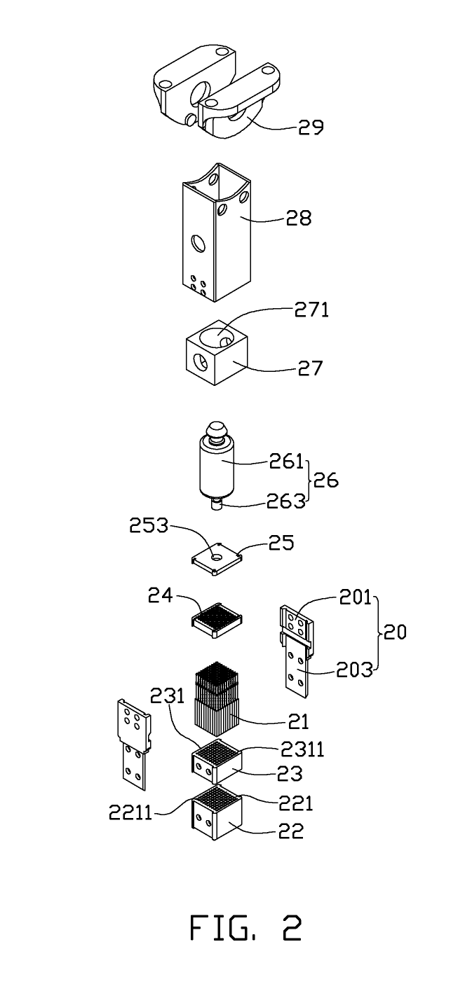

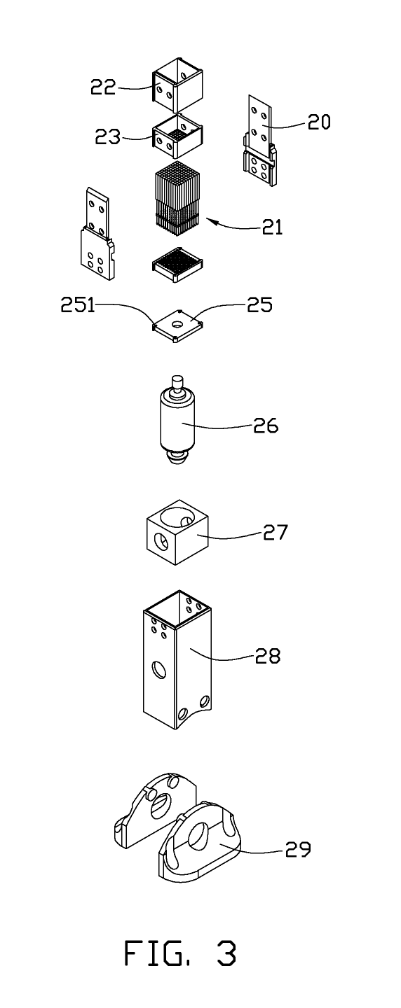

Referring to FIGS. 1 through 3, an embodiment of a clamping mechanism 200 includes a pair of clamping boards 20, an end executor 21, a first boot 22, a second boot 23, a contact member 24, a fixing board 25, a driving member 26, a holder 27, a housing 28, and a connecting member 29. The first boot 22 and the second boot 23 are positioned on the end executor 21, providing protection thereto. The driving member 26 is received in the housing 28. The connecting member 29 includes two parts mounted on both sides of the housing 28 adjacent to an end of the housing 28, connecting to a robot arm (not shown).

Each clamping board 20 includes a first clamping portion 201 and a second clamping portion 203 at an end of the first clamping portion 201. The first clamping portion 201 is used for clamping the contact member 24 and the fixing board 25, and the second clamping portion 203 is used for holding the first boot 22 and the second boot 23.

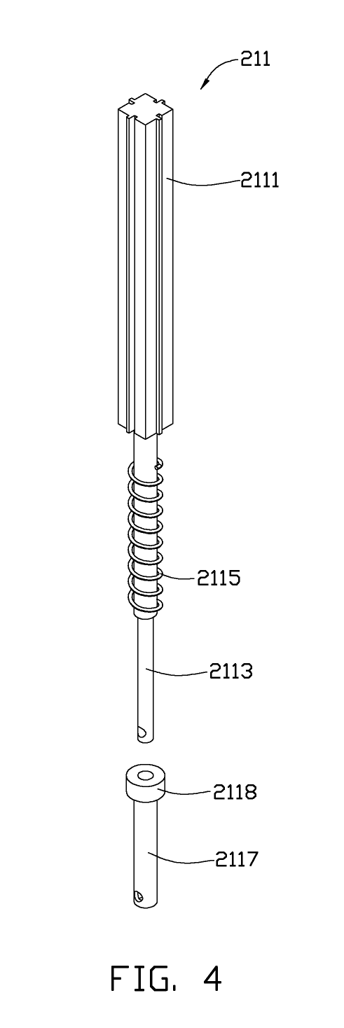

As shown in FIG. 4, the end executor 21 includes a plurality of claws 211 arranged in a matrix. Each claw 211 includes a rectangular main body 2111, an extending portion 2113 formed at an end of the main body 2111, an elastic member 2115, and a tube 2117. The elastic member 2115 is sleeved on the extending portion 2113. The tube 2117 forms a flange 2118 at an end for resisting the elastic member 2115 when the tube 2117 is sleeved on the extending portion 2113.

The first boot 22 is substantially rectangular, and forms a stopping board 221 at an end. The stopping board 221 defines a plurality of through holes 2211. A diameter of the through hole exceeds that of the tube 2117, but is less than that of the flange 2118, allowing the tube 2117 to pass through the through hole 2211. The flange 2118 may be blocked by the stopping board 211 to limit the tube 2118.

The second boot 23 is similar to the first boot 22, and forms a stopping board 231 at an end. The stopping board 231 defines a plurality of through holes 2311. A diameter of the through holes 2311 exceeds that of the tube 2117, but is less than that of the main body 2111 of the claw 211, allowing the tube 2117 to pass therethrough.

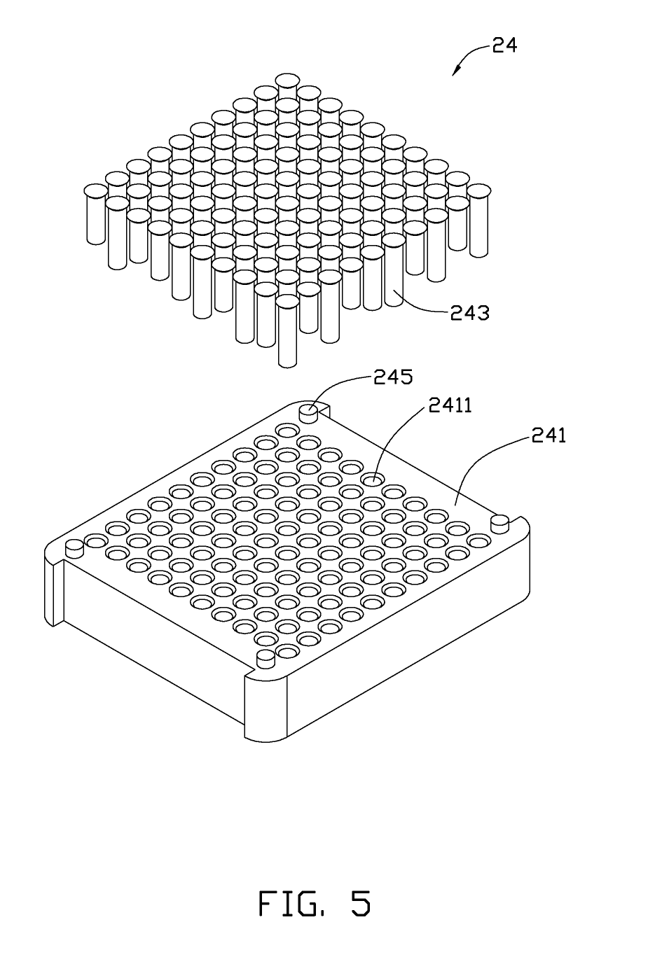

As shown in FIG. 5, the contact member 24 includes a substantially rectangular mounting board 241, a plurality of contact sleeves 243 and four positioning posts 245. The four positioning posts 245 are fixed at four corners of the mounting board 241 respectively. The mounting board 241 defines a plurality of mounting holes 2411 corresponding to the contact sleeves 243 respectively and each contact sleeve 243 is mounted in one of the mounting holes 2411. Some of the contact sleeves 243 may be of varying height to form a shaped matrix according to a workpiece to be clamped. In the illustrated embodiment, the mounting board 241 is made of iron. Alternatively, the mounting board 241 may be made of cobalt, nickel, or other magnetic materials.

The fixing board 25 defines a positioning groove 251 at each corner corresponding to the positioning post 245 of the mounting board 241. In the illustrated embodiment, the fixing board 25 is a magnet for attracting the mounting board 241. The driving member 26 includes a cylinder 261 and an output shaft 263 at an end of the cylinder 261. The output shaft 263 may extend out of the cylinder 261 and driven by the cylinder 261. The fixing board 25 defines a shaft hole 253 at a center thereof, allowing the output shaft 263 of the driving member 26 to pass through and resist the contact member 24. The holder 27 is substantially rectangular and defines a receiving hole 271 therein for receiving the cylinder 261.

In assembly, each claw 211 passes through one of the through holes 2211 and protrudes out of the first boot 22. The first boot 22 receives the main body 2111 of the claws 211, and arranges the claws 211 in matrix. Then, one end of the tube 2117 of the end executor 21 away from the flange 2118 passes the through hole 2311 of the second boot 23, and protrudes out of the second boot 23. The stopping board 231 of the second boot 23 abuts the stopping board 221 of the first boot 22. The tube 2117 is capable of sliding on the extending portion 2113, compressing the elastic member 2115. The first clamping portion 201 is mounted on a side of the first boot 22 and the second boot 23, thus to interconnect the firs boot 22 and the second boot 23. The fixing board 25 is attracted by the mounting board 241, and fixed on the mounting board 241. Each positioning post 245 is mounted in one of the positioning groove 251, to slidably position the mounting board 25 and the contact member 24 between the two clamping board 20. The cylinder 261 is fixed in the receiving hole 271. The holder 27 is fixed in the housing 28, and the housing 28 is fixed on the clamping board 20. The output shaft 263 of the driving member 26 passes the shaft hole 253 of the fixing board 25, and urges the mounting board 241 of the contact member 24, thus the contact member 24 may slide between the two clamping boards 20, driven by the contact member 26. The connecting member 29 is mounted on a side surface of the housing 28 away from the end executor 21. The connecting member 29 may be connected to the robot arm.

In use, a plurality of contact sleeves 243 with different heights may be prepared and arranged on the mounting board 241 of the contact member 24 according to a shape of the workpiece. The output shaft 263 extends and contacts the mounting board 241, driven by the cylinder 261, whereby the contact sleeves 243 can move the tubes 2117 respectively, to push the claws 211 out of the first boot 22 and fix the workpiece securely. The extending portion 2113 of the claw 211 may partially extend into the contact sleeve 243.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A clamping mechanism for holding a workpiece, comprising:
an end executor comprising a plurality of claws arranged in matrix;
a driving member and a contact member detachably mounted on the end executor, wherein the contact member comprises a mounting board and a plurality of contact sleeves corresponding to the claws, the driving member drives the mounting board thereby forcing the contact sleeves to push the claws out and hold the workpiece.

2. The clamping mechanism of claim 1, wherein the clamping mechanism further comprises a housing fixed on the end executor and a magnetic fixing board, the mounting board is a magnet attracting the fixing board to fix the fixing board on the mounting board.

3. The clamping mechanism of claim 2, wherein the mounting board forms a positioning post, and the fixing board defines a positioning groove receiving the positioning post to fix the mounting board on the fixing board.

4. The clamping mechanism of claim 2, wherein the clamping mechanism further comprises a holder fixed in the housing and receiving the driving member.

5. The clamping mechanism of claim 4, wherein the driving member comprises a cylinder and an output shaft driven by the cylinder, and the fixing board defines a shaft hole for the output shaft passing through and driving the mounting board.

6. The clamping mechanism of claim 1, wherein each claw comprises a main body, an extending portion formed on the main body, an elastic member sleeved on the extending portion, and a tube sleeved on the extending portion and capable of sliding on the extending portion, thereby compressing the elastic member, and the contact sleeve urges the tube.

7. The clamping mechanism of claim 6, wherein the clamping mechanism further comprises a first boot sleeved on the end executor and receiving the main body of the claw.

8. The clamping mechanism of claim 7, wherein the clamping mechanism further comprises a second boot having a stopping board, and the tube of the claw forms a flange corresponding to the stopping board, so that the flange can be blocked by the stopping board to prevent the claw detaching from the second boot.

9. The clamping mechanism of claim 8, wherein the clamping mechanism further comprises two clamping boards, each clamping board comprises a first clamping portion interconnecting the first boot and the second boot, and the clamping boards cooperatively hold the first boot and the second boot.

10. The clamping mechanism of claim 9, wherein each clamping board further comprises a second clamping portion formed on the first clamping portion, and the contact member is slidably positioned between the second clamping portions of the two clamping boards.
